(19) United States
(12) Patent Application Publication
(10) Pub. No.: US 2025/0347449 A1
(43) Pub. Date: Nov. 13, 2025

(54) Refrigerator and Operation Control Method for Refrigerator

(71) Applicant: Anker Innovations Technology Co., Ltd., Changsha City (CN)

(72) Inventor: Cong Han, Shenzhen (CN)

(21) Appl. No.: 19/200,223

(22) Filed: May 6, 2025

(30) Foreign Application Priority Data
May 9, 2024 (CN) 202410574460.9

(51) Int. Cl. F25B 27/00; F25B 13/00

(52) U.S. Cl. CPC F25B 27/00; F25B 13/00

(57) ABSTRACT

Disclosed are an operation control method of a refrigerator and a refrigerator. Where the refrigerator is in the battery-powered refrigeration mode, the battery temperature of the refrigerator battery may be acquired and compared with a range of temperatures. When the battery temperature is between the first preset temperature and the second preset temperature, the compressor of the refrigerator may be controlled to operate at a lower tap position. When the battery temperature is too high, the operation tap position of the compressor may be lowered.

### CROSS-REFERENCE TO RELATED APPLICATION

The present application claims priority to Chinese Patent Application No. 202410574460.9, filed on May 9, 2024, which is herein incorporated by reference by its entirety.

### FIELD

The present disclosure relates to the technical field of refrigeration, in particular to a refrigerator and an operation control method for a refrigerators.

### BACKGROUND

An outdoor refrigerator, such a car refrigerator, is a refrigerator which can be powered by a car power supply or a battery. Such refrigerators may be used in cars or other outdoor scenes. Because of its advantages of portability and strong adaptability, the refrigerator is deeply loved by users.

However, due to factors such as sun exposure and trunk placement, the battery operating temperature of the outdoor/car refrigerator can become too high, which seriously affects use safety of the battery.

### SUMMARY

Aspects described herein describe a unique refrigerator and provide an operation control method of a refrigerator so as to lower an operating temperature of a battery as much as possible and improve use safety of the battery.

In a first aspect, the disclosure provides an operation control method of a refrigerator. This operation control method may comprise one or more steps, such as acquiring battery temperature of the refrigerator in real time in a case where the refrigerator is in a battery-powered refrigeration mode; in a case where the battery temperature is greater than a first preset temperature and lower than a second preset temperature, controlling a compressor of the refrigerator to operate at a lower tap position, wherein the first preset temperature and the second preset temperature are both lower than a preset protection temperature; and/or, in a case where the battery temperature is lower than or equal to the first preset temperature, controlling the compressor to operate at a current tap position.

In a second aspect, the disclosure provides a refrigerator that may comprise a compressor, an evaporator, a capillary, a condenser, a fan, a battery and/or a controller.

The compressor may be connected with the evaporator and the condenser. The condenser may be connected with the capillary. The capillary may be connected with the evaporator. The fan may be provided on and/or otherwise connected with the condenser. The compressor, the evaporator, the condenser, the fan and/or the controller may be separately connected with the battery. The compressor, the evaporator, the condenser and the fan may be separately connected with the controller. The controller may be configured to perform the above steps of the operation control method of the refrigerator.

According to the operation control method of the refrigerator and the structure of the refrigerator, in the case where the refrigerator is in the battery-powered refrigeration mode, the battery temperature of the refrigerator battery may be acquired in real time and may be compared with the first preset temperature and the second preset temperature which are lower than the preset protection temperature. When the battery temperature is between the first preset temperature and the second preset temperature, the compressor of the refrigerator may be controlled to operate at a lower tap position, and when the battery temperature is lower than or equal to the first preset temperature, the tap position of the compressor may be kept unchanged. Through this solution, when the battery temperature exceeds a threshold (e.g., is too high), that is, when the battery temperature is between the first preset temperature and the second preset temperature, the operation tap position of the compressor may be modified (e.g., lowered), so as to reduce the discharge amount of the battery, and further reduce the heat amount of the battery. In this way, in the process of starting the refrigerator, the operating temperature of the battery may be lowered as much as possible to improve the use safety of the battery.

### BRIEF DESCRIPTION OF DRAWINGS

In order to more clearly illustrate the disclosure, drawings are introduced below. The drawings are illustrative and only show some examples of the disclosure.

FIG. 1 is a schematic flowchart of an operation control method of a refrigerator;

FIG. 2 is a schematic flowchart of an operation control method of a refrigerator;

FIG. 3 is a schematic flowchart of an operation control method of a refrigerator;

FIG. 4 is a schematic flowchart of an operation control method of a refrigerator;

FIG. 5 is a schematic flowchart of an operation control method of a refrigerator;

FIG. 6 is a schematic diagram of a refrigerator structure;

FIG. 7 is a schematic front view of a refrigerator structure;

FIG. 8 is a schematic front view of a refrigerator structure;

FIG. 9 is a schematic plan view of a refrigerator structure; and

FIG. 10 is a schematic plan view of a refrigerator structure.

### DETAILED DESCRIPTION

The present disclosure is described below, including with reference to the accompanying drawings. Various examples of the present disclosure may be shown in the accompanying drawings. However, the present disclosure may be implemented in many different forms and is not limited to the examples described herein. Rather, these examples are merely provided to illustrate various contents of the disclosure.

An operation control method of a refrigerator may be applied to a refrigerator that can perform refrigeration by battery-powered operation. For example, such a refrigerator may be a car refrigerator or an outdoor refrigerator. When this type of refrigerator operates in battery-powered refrigeration mode, that is, refrigeration is performed by battery power supply, battery discharging may generate a lot of heat, which eventually may make the battery temperature rise continuously. For some batteries, battery discharge amount may be positively correlated with a battery temperature. In turn, in some circumstances, the greater the battery discharge amount, the higher the battery temperature. It has been found through research that the battery discharge amount may be directly correlated with an electrical load, and the greater the power of the electrical load, the greater the battery discharge amount may be. Thus, for example, when the refrigerator performs refrigeration by battery power supply, the battery temperature may be monitored in real time, and when the battery temperature is high, a tap position of a compressor may be lowered to reduce the battery discharge amount, thereby slowing down the rise of the battery temperature to a certain extent, thereby possibly avoiding high working temperature of the battery improving the use safety of the battery.

Further, through in-depth research, it has been found that a battery of a refrigerator may be generally provided in a bin together with the compressor at present, and the battery temperature may also be affected by a compressor temperature, that is, a bin temperature may rise with the rise of the compressor temperature, and thus the battery temperature may rise. While lowering the tap position of the compressor to operate, a heat amount of the compressor may be effectively reduced, thereby potentially reducing the bin temperature, and potentially alleviating the phenomenon of battery heating to a certain extent.

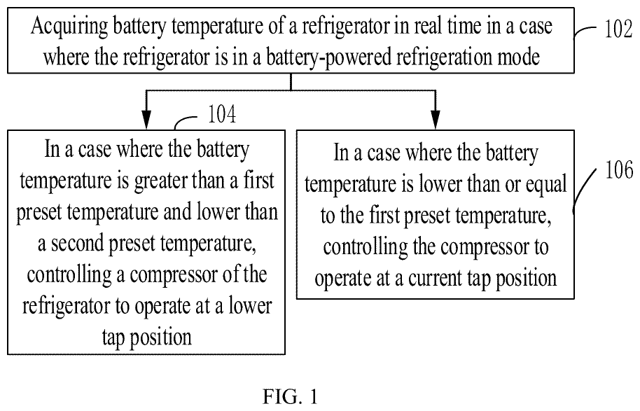

Referring to FIG. 1, the disclosure provides an operation control method of a refrigerator, which includes steps 102, 104 and 106.

In step 102, in a case where the refrigerator is in a battery-powered refrigeration mode, battery temperature of the refrigerator may be acquired in real time.

The battery-powered refrigeration mode may be a mode in which the refrigerator uses a battery as an energy source, supplies power to refrigeration related devices through the battery, and/or starts refrigeration operation. The battery temperature may be a real-time temperature of the battery in the refrigerator. When the refrigerator operates in the battery-powered refrigeration mode, a controller of the refrigerator might monitor the battery temperature in real time so as to determine the battery temperature.

There may be various different ways to acquire the battery temperature. For example, the controller may communicate with temperature detectors provided in a cell, and analyze (for example, average calculation) cell temperatures collected by the temperature detectors to acquire the battery temperature. As another example, the controller may communicate with a battery management system (BMS) of the battery, and the controller directly acquires the battery temperature from the BMS, which is not specifically limited.

In step 104, if the battery temperature is greater than a first preset temperature and lower than a second preset temperature, a compressor of the refrigerator may be controlled to operate at a lower tap position.

The first preset temperature and the second preset temperature may be both lower than a preset protection temperature. The preset protection temperature may be a preset minimum battery temperature during battery shutdown protection. While the battery is operating, battery performance may be attenuated when the battery temperature is too high or too low, and the battery might easily catch fire when the battery temperature is higher than a certain value. Therefore, the preset protection temperature, the first preset temperature and the second preset temperature may be pre-stored in the controller, and in a case where the battery temperature is greater than the preset protection temperature, the battery may be at risk of fire and might be shut down for protection at this time. Moreover, in a case where the battery temperature is between the first preset temperature and the second preset temperature, the battery might not be unstable at that time, but might need to be cooled to meet requirements of continuous operation.

The preset protection temperature, such as the first preset temperature and the second preset temperature, need not be unique and may be different according to different battery models. For example, the preset protection temperature may be set to be lower than or equal to 70° C., the first preset temperature and the second preset temperature may set to be lower than the preset protection temperature, and the first preset temperature may be further lower than the second preset temperature.

Therefore, when the refrigerator is in the battery-powered refrigeration mode, after acquiring the battery temperature, the controller may compare the battery temperature with the first preset temperature and the second preset temperature, and if the battery temperature is between the first preset temperature and the second preset temperature, the compressor of the refrigerator may be controlled to operate at a lower tap position, so as to reduce the discharge amount and heat amount of the battery and alleviate the phenomenon that the battery temperature rises.

In step 106, in a case where the battery temperature is lower than or equal to the first preset temperature, the compressor may be controlled to operate at the current tap position.

In some circumstances, when the controller compares the battery temperature with the first preset temperature and the second preset temperature, the battery temperature may be lower than or equal to the first preset temperature, and the low battery temperature might not cause battery instability and may be able to meet the requirements of continuous refrigeration operation. In such a circumstance, when the controller detects that the battery temperature is lower than or equal to the first preset temperature, there might be no need to adjust the operation of the compressor, and the compressor may be kept operating at the current tap position.

According to the operation control method of the refrigerator, in the case where the refrigerator is in the battery-powered refrigeration mode, the battery temperature of the refrigerator battery may be acquired in real time and may be compared with the first preset temperature and the second preset temperature which are lower than the preset protection temperature. When the battery temperature is between the first preset temperature and the second preset temperature, the compressor of the refrigerator may be controlled to operate at a lower tap position, and when the battery temperature is lower than or equal to the first preset temperature, the tap position of the compressor may be kept unchanged. For example, when the battery temperature is too high, for instance, when the battery temperature is between the first preset temperature and the second preset temperature, the operation tap position of the compressor may be lowered so as to reduce the discharge amount of the battery and so as to further reduce the heat amount of the battery. In this way, in the process of starting the refrigerator, the operating temperature of the battery may be lowered as much as possible to improve the use safety of the battery.

In the case where the battery temperature is greater than the first preset temperature and lower than the second preset temperature, the operation control method of the refrigerator may include controlling a fan of the refrigerator to operate at a higher tap position. In such a circumstance, the battery and the fan of the refrigerator may be provided inside the same bin.

Specifically, the battery and the fan of the refrigerator may be provided inside the same bin. For example, both the battery and the fan may be provided inside a compressor bin, so that the airflow formed when the fan of the refrigerator operates can flow through the battery, which has a certain cooling effect on the battery. Therefore, to further improve the cooling efficiency of the battery, while the battery is cooled by lowering the tap position of the compressor, the fan may be controlled to operate at a higher tap position, thereby taking more heat away from the battery.

When the refrigerator is in the battery-powered refrigeration mode, if the battery temperature is between the first preset temperature and the second preset temperature, the battery might be cooled by lowering the compressor tap position, such that the tap position of the fan remains unchanged. This approach to cooling might be selected based on design needs.

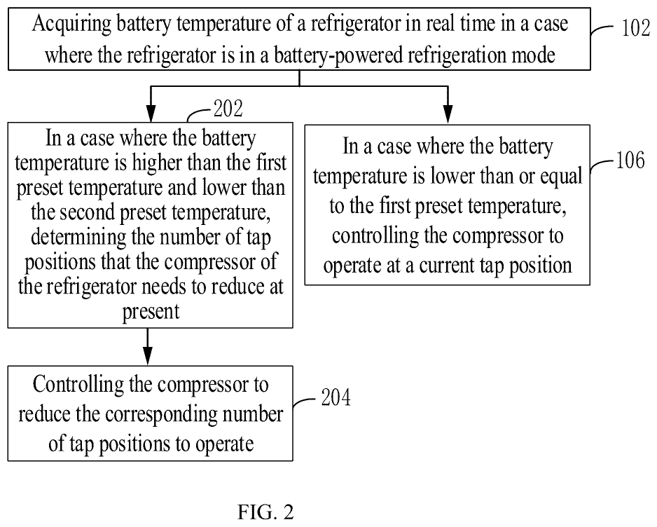

Referring to FIG. 2, step 104 may include step 202 and step 204.

In Step 202, a device, such as the controller, may determine the number of tap positions that the compressor of the refrigerator needs to reduce at present in a case where the battery temperature is higher than the first preset temperature and lower than the second preset temperature.

In Step 204, a device, such as the controller, may control the compressor to reduce the corresponding number of tap positions to operate.

Specifically, when the battery temperature is between the first preset temperature and the second preset temperature and the battery temperature is lowered by lowering the tap position of the compressor, the number of tap positions that the compressor needs to reduce need not be unique and fixed, and the number of tap positions to be reduced might be different depending on different actual magnitudes of the battery temperature. Accordingly, the number of tap positions that the compressor needs to reduce at present may be first determined based on the actually acquired battery temperature, and then the compressor is controlled to operate at a lower tap position by the determined number of tap positions.

In this way, the compressor may be controlled to operate by reducing the number of tap positions needed. This approach may meet the requirements of rapid refrigeration of the refrigerator and effectively improve adjustment accuracy of the battery temperature.

The way to determine the number of tap positions that the compressor needs to reduce at present need not be unique. The interval range determined by the first preset temperature and the second preset temperature may be divided into different temperature intervals, and the number of tap positions that the compressor needs to reduce may also be set different in different temperature intervals. For example, the greater the battery temperature, the greater the number of tap positions that the compressor might need to reduce so as to lower the battery temperature at a faster speed.

The interval range determined by the first preset temperature and the second preset temperature may be divided into two or more temperature intervals. In the present disclosure, two temperature intervals are used as an example for explanation; however, any number/variety of temperature thresholds may be used.

Step 202 may include, in a case where the battery temperature is higher than the first preset temperature and lower than a third preset temperature, determining to reduce the number of tap positions to a first number of tap positions. In a case where the battery temperature is higher than or equal to a third preset temperature and lower than the second preset temperature, this may include determining that the number of tap positions that the compressor of the refrigerator needs to reduce at present is a second number of tap positions. In such a circumstance, the second number of tap positions may be greater than the first number of tap positions.

In some cases, a temperature interval range may be determined according to the first preset temperature and the third preset temperature, and a temperature interval range may be determined according to the third preset temperature and the second preset temperature. When the battery temperature is relatively low between the first preset temperature and the third preset temperature, the compressor might reduce the first number of tap positions to meet battery cooling requirements; however, when the battery temperature is relatively high between the third preset temperature and the second preset temperature, the compressor might reduce a greater second number of tap positions to meet the battery cooling requirements.

The first number of tap positions and the second number of tap positions need not be unique. With that said, in some circumstances, the first number of tap positions may be less than the second number of tap positions. For example, the first number of tap positions may be set as a first tap position and the second number of tap positions may be set as a second tap position.

The temperature interval determined by the first preset temperature and the second preset temperature may be further divided into two stages, and the compressor is controlled to lower different tap positions at different stages, which can effectively improve accuracy of adjustment of the battery temperature.

When the battery temperature is between the first preset temperature and the second preset temperature, the temperature interval determined by the first preset temperature and the second preset temperature may be further divided into a plurality of temperature intervals in a way similar to the compressor tap position lowering control, and the higher the temperature values of the temperature interval, the more the number of tap positions the fan increases, so as to realize cooling control of the battery more quickly.

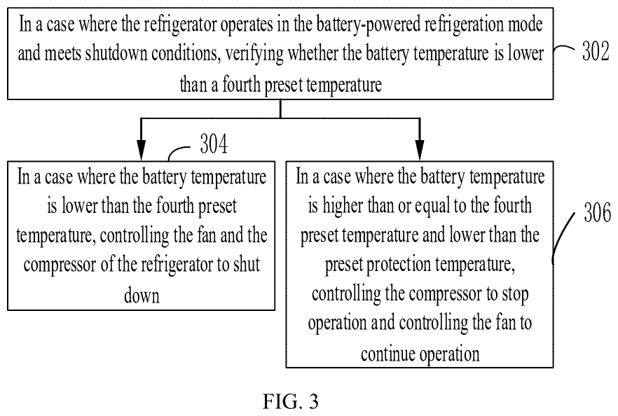

Referring to FIG. 3, the operation control method of a refrigerator may include steps 302, 304 and 306.

In step 302, in a case where the refrigerator operates in the battery-powered refrigeration mode and meets shutdown conditions, the step may include verifying whether the battery temperature is lower than a fourth preset temperature.

In step 304, in a case where the battery temperature is lower than the fourth preset temperature, the step may include controlling the fan and the compressor of the refrigerator to shut down.

In step 306, in a case where the battery temperature is higher than or equal to the fourth preset temperature and lower than the preset protection temperature, the step may include controlling the compressor to stop operation and controlling the fan to continue operation.

For example, the shutdown conditions may be conditions under which the refrigerator temporarily stops refrigeration. When the refrigerator operates in the battery-powered refrigeration mode, the compressor and the fan might be adjusted depending upon the battery temperature during operation, and whether the shutdown conditions are met may also be monitored in real time. After the refrigerator meets the shutdown conditions, the controller may compare the battery temperature with the fourth preset temperature. If the battery temperature is lower than the fourth preset temperature, it means that the current battery temperature might be low, and there may be no need to perform additional cooling on the battery. In this case, refrigeration might be temporarily stopped by directly causing the compressor and the fan of the refrigerator to shut down.

When the battery temperature is between the fourth preset temperature and the preset protection temperature, the current battery temperature may be too high. In order to ensure that the battery temperature is kept at a low level to further improve battery operation safety when operation is started next time, the controller may control the compressor to stop operation, and, meanwhile, may control the fan to operate so that the air on the battery surface flows by operation of the fan, thereby lowering the battery temperature.

The way to determine whether the refrigerator meets the shutdown conditions might not be unique or unusual, and may comprise determining whether the refrigerator reaches a shutdown temperature. The refrigerator may have a set temperature. In turn, it may be desirable to keep the refrigerator at the set temperature (for example, 5° C.) by refrigeration. A startup temperature and a shutdown temperature may be determined by the set temperature, where the startup temperature may be slightly higher than the set temperature (for example, 6° C.) and the shutdown temperature may be slightly lower than the set temperature (for example, 4° C.). When the refrigerator continues refrigeration and the temperature inside the refrigerator is lower than or equal to the shutdown temperature, the shutdown conditions may be are met, and refrigeration may be stopped.

It may be determined whether the refrigerator receives shutdown instructions, and when the refrigerator receives those shutdown instructions, it may be considered that the refrigerator meets the shutdown conditions.

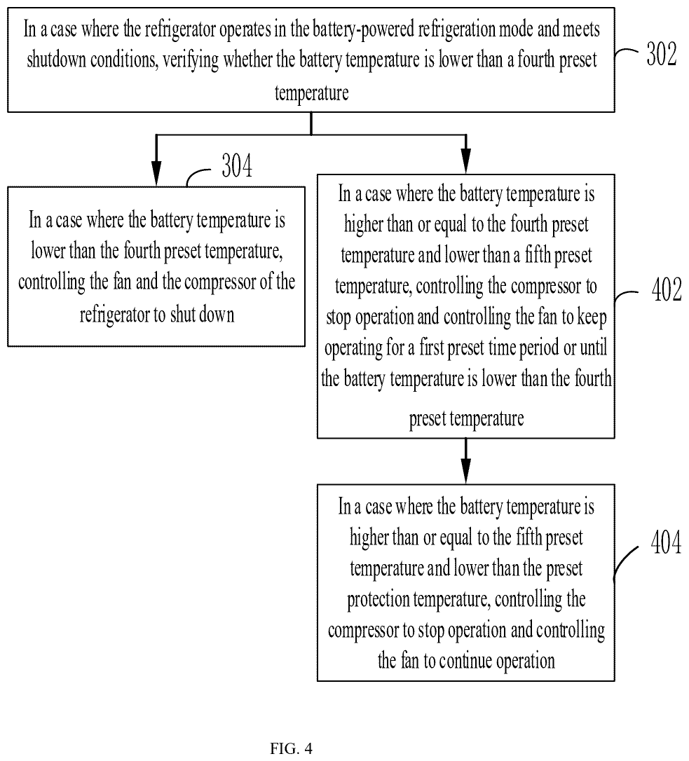

Referring to FIG. 4, step 306 may include step 402 and step 404.

In step 402, if the battery temperature is higher than or equal to the fourth preset temperature and lower than a fifth preset temperature, the step may comprise controlling the compressor to stop operation and controlling the fan to keep operating for a first preset time period or until the battery temperature is lower than the fourth preset temperature.

In step 404, in a case where the battery temperature is higher than or equal to the fifth preset temperature and lower than the preset protection temperature, the step may comprise controlling the compressor to stop operation and controlling the fan to continue operation.

The temperature interval may be determined by the fourth preset temperature, and the preset protection temperature may be further divided into two temperature intervals. When the battery temperature is in a smaller temperature interval, that is, between the fourth preset temperature and the fifth preset temperature, the battery temperature may be relatively low, and it may be desirable to keep the fan operating for a period of time to cool the battery. However, when the battery is in a large temperature interval, that is, between the fifth preset temperature and the preset protection temperature, it may be desirable to control the fan to continue operation, so as to lower the battery temperature as much as possible.

When the battery temperature is between the fourth preset temperature and the fifth preset temperature, the fan may be controlled to operate for a period of time, such as for the fixed first preset time period or until the battery temperature is lowered to lower than the fourth preset temperature. The selection of either approach may be based on design preferences and the overall function of, for example, the fan.

The fan of the refrigerator may automatically start operation when the refrigerator is turned on, in the subsequent process, the fan may continue operation until the refrigerator is powered off, and then the fan stops operation. Additionally and/or alternatively, the fan may automatically start operation when the refrigerator is turned on, and then stops operation if a temperature of the refrigeration-related device of the refrigerator is detected to be lower than a certain threshold; and when the temperature of the refrigeration-related device is detected to be higher than a certain threshold, the fan may start operation again.

The temperature interval for controlling operation of the fan may be divided into two, and the fan may be controlled to operate in different modes in different temperature intervals, so that the battery temperature is lowered as much as possible through operation of the fan, improving the use safety of the battery.

The operation control method of a refrigerator may further include: in a case where the refrigerator has battery-powered operation requirements, verifying whether the battery temperature is lower than the preset protection temperature; in a case where the battery temperature is lower than the preset protection temperature, controlling the refrigerator to start operation; and/or, in a case where the battery temperature is higher than or equal to the preset protection temperature, controlling the refrigerator to stop operation, at which time the battery is in a protected state.

The refrigerator may have battery-powered operation requirements, that is, the refrigerator may have battery-powered requirements to perform refrigeration operation. The refrigerator may have battery-powered operation requirements when the refrigerator receives power-on instructions. In this case, the controller may self-detect the battery temperature. In a case where the self-detected battery temperature is lower than the preset protection temperature, the controller may allow the refrigerator to start up, or otherwise may control the battery to enter a protected state and does not allow the refrigerator to start up, that is, it may control the refrigerator to stop operation and interrupts the startup operation of the refrigerator.

Through the above solution, when the refrigerator needs to be powered by a battery, the battery temperature may be detected first, and then the refrigerator may be controlled to start up according to the detected result, which can effectively ensure that the refrigerator starts up in the case where the battery temperature is lower than the preset protection temperature, and improve startup safety of the battery.

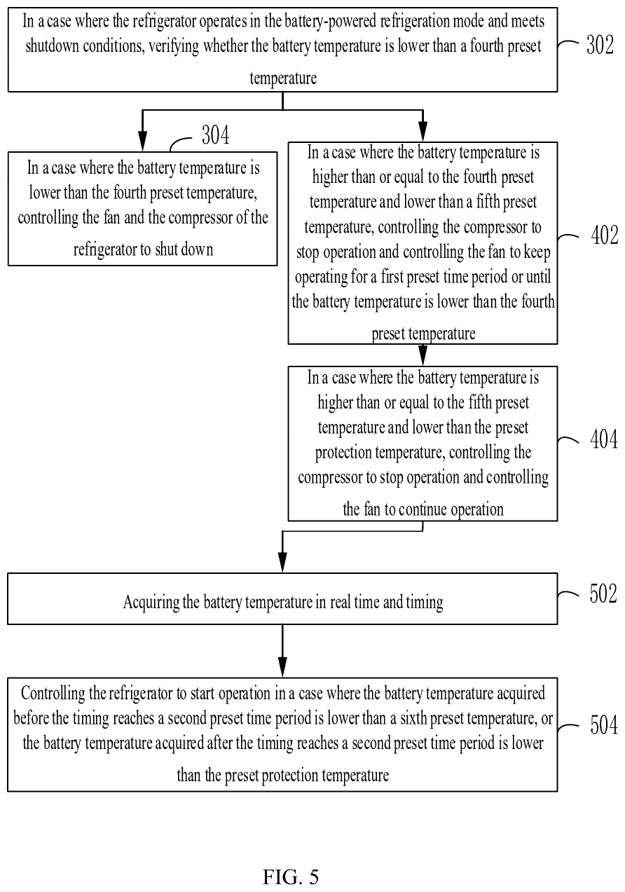

Further, referring to FIG. 5, after step 404, the method may further include steps 502 and 504.

Step 502 may comprise acquiring the battery temperature in real time and timing.

Step 504 may comprise controlling the refrigerator to start operation in a case where the battery temperature acquired before the timing reaches a second preset time period is lower than a sixth preset temperature, and/or when the battery temperature acquired after the timing reaches a second preset time period is lower than the preset protection temperature.

The sixth preset temperature may be lower than the preset protection temperature. After the battery is controlled to enter the protected state, it is not that the refrigerator might not start operation at all, but the refrigerator may instead wait for the battery to cool naturally for the second preset time period. After the battery enters the protected state, the controller may perform waiting for a second preset time period, and may acquire the battery temperature in real time for analysis during the waiting process. If the battery temperature has decreased to lower than the sixth preset temperature before the timing reaches the second preset time period, the battery may be controlled to exit the protected state and supply power to other devices in the refrigerator through the battery, so as to control the refrigerator to start operation. Or, if it is detected that the battery temperature has been lower than the preset protection temperature after the second preset time period, the battery may be controlled to exit the protected state and supplies power to other devices in the refrigerator through the battery, so as to control the refrigerator to start operation.

The battery temperature may be detected to be higher than the preset protection temperature at the startup stage of the refrigerator, and/or if the battery enters the protected state, then the controller may wait for a period of time, and may acquire the battery temperature in real time during the waiting process, so as to analyze whether the battery temperature has decreased, and may control the battery to exit the protected state and control the refrigerator to start operation when the battery temperature decreases to certain conditions, which can effectively improve a success rate of startup of the refrigerator.

The discussion below provides an illustrative example of how many of the aspects described herein may be performed.

First, in the case where a refrigerator has battery-powered operation requirements, the controller may acquire the battery temperature and compare the battery temperature with the preset protection temperature, and if the battery temperature is lower than the preset protection temperature, the refrigerator may be controlled to start operation (refrigeration related devices such as a compressor and a fan); if the battery temperature is higher than or equal to the preset protection temperature, the battery may be controlled to enter the protected state, and the battery temperature may be continuously monitored. In the case where the battery temperature is monitored to decrease to lower than the sixth preset temperature when the timing does not reach the second preset time period, or the battery temperature is monitored to be lower than the preset protection temperature when the timing reaches the second preset time period, the refrigerator may be controlled to start operation.

The acquired battery temperature may be compared with the first preset temperature, for instance, the second preset temperature and the third preset temperature in the case where the refrigerator is in the battery-powered refrigeration mode. In the case where the battery temperature is lower than or equal to the first preset temperature, the compressor and the fan are may be controlled to operate at the current tap position; in the case where the battery temperature is higher than the first preset temperature and lower than the third preset temperature, the compressor of the refrigerator may be controlled to operate by reducing one tap position, and the fan is controlled to operate at the current tap position or by increasing one tap position; in the case where the battery temperature is higher than or equal to the third preset temperature and lower than the second preset temperature, the compressor of the refrigerator may be controlled to operate by reducing two tap positions, and the fan may be controlled to operate at the current tap position or by increasing two tap positions.

Finally, whether the battery temperature is lower than the fourth preset temperature may be determined in the case where the refrigerator is detected to operate in the battery-powered refrigeration mode and meet the shutdown conditions. In the case where the battery temperature is lower than the fourth preset temperature, the fan and compressor of the refrigerator may be controlled to shut down; in the case where the battery temperature is higher than or equal to the fourth preset temperature and lower than the fifth preset temperature, the compressor may be controlled to stop operation, and the fan is controlled to keep operating for a first preset time period, or to keep operating until the battery temperature is lower than the fourth preset temperature; in the case where the battery temperature is higher than or equal to the fifth preset temperature and lower than the preset protection temperature, the compressor may be controlled to stop operation, and the fan is controlled to continue operation.

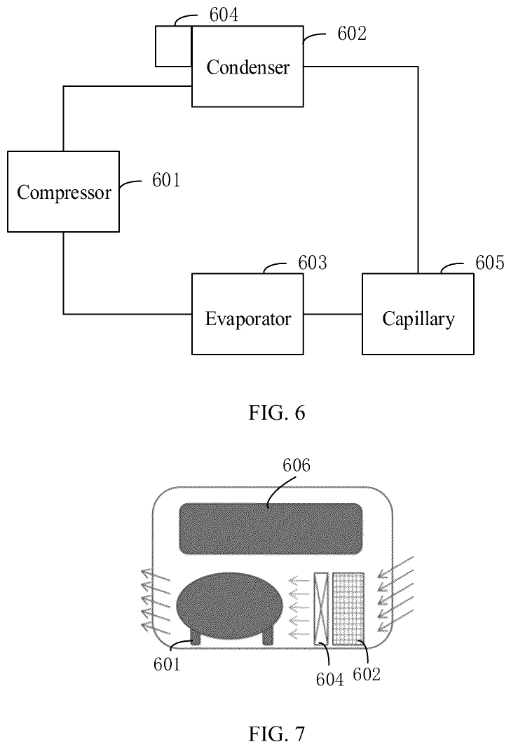

Referring to FIG. 6, a refrigerator may include a compressor 601, an evaporator 603, a capillary 605, a condenser 602, a fan 604, a battery (not shown in the drawings) and a controller (not shown in the drawings). The compressor 601 may be connected with the evaporator 603 and the condenser 602, the condenser 602 may be connected with the capillary 605, and the capillary 605 may be connected with the evaporator 603. The fan 604 may be provided on the condenser 602. The compressor 601, the evaporator 603, the condenser 602, the fan 604 and the controller may be separately connected with the battery, and the compressor 601, the evaporator 603, the condenser 602 and the fan 604 may be separately connected with the controller. The controller may be configured to perform the steps of the operation control method of the refrigerator.

The location of the fan 604 may be in a variety of locations, and the fan 604 may be provided on a side surface or a top surface of the condenser 602. The fan 604 may be provided on a side surface of the condenser 602 close to the compressor 601. In the case where the refrigerator is in the battery-powered refrigeration mode, the battery temperature of the refrigerator battery may be acquired in real time and is compared with the first preset temperature and the second preset temperature which are lower than the preset protection temperature. When the battery temperature is between the first preset temperature and the second preset temperature, the compressor 601 of the refrigerator may be controlled to operate at a lower tap position, and when the battery temperature is lower than or equal to the first preset temperature, the tap position of the compressor 601 may be kept unchanged. Through this solution, when the battery temperature is too high, that is, when the battery temperature is between the first preset temperature and the second preset temperature, the operation tap position of the compressor 601 may be lowered, so as to reduce the discharge amount of the battery, and further reduce the heat amount of the battery. In this way, in the process of starting the refrigerator, the operating temperature of the battery may be lowered as much as possible to improve the use safety of the battery.

The refrigerator may be provided with a compressor bin, and the battery, the compressor 601, the condenser 602 and the fan 604 may be provided inside the compressor bin.

For example, the battery and the compressor 601 of the refrigerator may be provided in a bin together, and the battery temperature may also be affected by a temperature of the compressor 601, that is, a bin temperature may rise with the rise of a temperature of the compressor 601, and thus the battery temperature may rise. In this way, by lowering the tap position of the compressor 601 to operate, the heat amount of the battery may be reduced, and meanwhile the heat amount of the compressor 601 may also be effectively reduced, thereby reducing the bin temperature, and finally alleviating the phenomenon of battery heating to a certain extent.

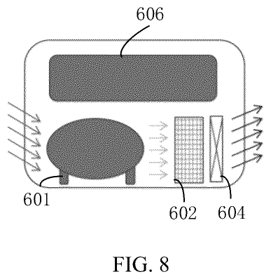

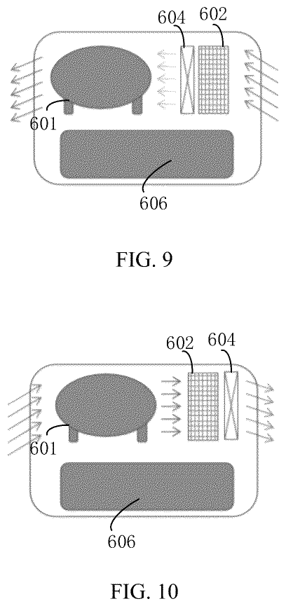

It should be noted that the arrangement of the battery, the compressor 601, the condenser 602 and the fan 604 may be in a variety of ways, including inside or outside the same bin. The compressor 601, the condenser 602 and the fan 604 may be taken as an integral component, and the battery may be provided at any position around the integral component formed by the compressor 601, the condenser 602 and the fan 604, as long as the airflow generated during operation of the fan 604 can flow through the battery. For example, a battery 606 may be provided above (with reference to FIGS. 7 and 8) or below the integral component formed by the compressor 601, the condenser 602 and the fan 604, or on a side surface of the integral component formed by the compressor 601, the condenser 602 and the fan 604 (with reference to FIGS. 9 and 10).

Further, as shown in FIG. 7 or FIG. 9, the compressor 601, the fan 604 and the condenser 602 may be arranged in parallel, the fan 604 is located between the condenser 602 and the compressor 601, the condenser 602 is provided at an air inlet of the fan 604, and the compressor 601 is provided at an air outlet of the fan 604, so that the airflow output by the fan 604 passes through the battery 606 and the compressor 601 to cool the battery 606 and the compressor 601.

In detail, considering an air path of the whole component formed by the compressor 601, the condenser 602 and the fan 604, a temperature of the passing air may have a certain influence on the cooling of the battery 606. The lower the temperature of the air passing through the battery 606, the more heat of the battery 606 might be able to be taken away, and the better the cooling effect on the battery 606. Therefore, in order to improve the cooling efficiency of the battery 606 and the compressor 601, the compressor 601, the fan 604 and the condenser 602 may be provided in parallel, the condenser 602 may be provided between the compressor 601 and the fan 604, and the condenser 602 may be provided at the air inlet of the fan 604, referring to FIG. 8 or FIG. 10. In this way, the cold air may pass through the compressor 601 and the battery 606 first, cool the compressor 601 and the battery 606 by the flow of the cold air, which has higher cooling efficiency.

Various technical features provided above can be combined as desired. To make the description concise, not all possible combinations of the technical features are described. In turn, a wide variety of combinations should be considered within the scope of the description.

The details described above represent only several examples of the present disclosure, which are described in detail but should not be construed as limitations of the scope of the disclosure. It should be noted that several variations and improvements can be made without departing from the spirit of the disclosure for those skilled in the art, all of which fall within the scope of the present disclosure. Accordingly, the scope of the present disclosure should be subject to the appended claims.

What is claimed is:

1. A method for controlling a battery-powered refrigerator, the method comprising:
acquiring, for a refrigerator operating in a battery-powered refrigeration mode, a battery temperature of the refrigerator;
based on determining that the battery temperature is greater than a first preset temperature and lower than a second preset temperature, causing a compressor of the refrigerator to operate at a lower tap position, wherein the first preset temperature and the second preset temperature are both lower than a preset protection temperature; and
based on determining that the battery temperature is lower than or equal to the first preset temperature, causing the compressor to operate at a current tap position.

2. The method of claim 1, further comprising:
based on the determining that the battery temperature is greater than the first preset temperature and lower than the second preset temperature, cause a fan of the refrigerator to operate at a higher tap position, wherein the battery and the fan of the refrigerator are provided inside a same bin.

3. The method of claim 1, further comprising:
based on the determining that the battery temperature is greater than the first preset temperature and lower than the second preset temperature, determining a number of tap positions to reduce; and
causing the compressor to reduce the number of tap positions.

4. The method of claim 1, further comprising:
based on determining that the battery temperature is higher than the first preset temperature and lower than a third preset temperature, determining a first number of tap positions; and
based on determining that the battery temperature is higher than or equal to the third preset temperature and lower than the second preset temperature, determining a second number of tap positions, wherein the second number of tap positions is greater than the first number of tap positions.

5. The method of claim 1, further comprising:
based on determining that the refrigerator operates in the battery-powered refrigeration mode and meets shutdown conditions, determining whether the battery temperature is lower than a fourth preset temperature;
based on determining that the battery temperature is lower than the fourth preset temperature, causing the fan and the compressor to shut down; and
based on determining that the battery temperature is higher than or equal to the fourth preset temperature and lower than the preset protection temperature, causing the compressor to stop operation and causing the fan to continue operation.

6. The method of claim 5, wherein the causing the compressor to stop operation and the causing the fan to continue operation comprises:
based on determining that the battery temperature is higher than or equal to the fourth preset temperature and lower than a fifth preset temperature, causing the compressor to stop operation and causing the fan to keep operating for until one or more of:
a first preset time period, or
the battery temperature is lower than the fourth preset temperature; and
based on determining that the battery temperature is higher than or equal to the fifth preset temperature and lower than the preset protection temperature, causing the compressor to stop operation and causing the fan to continue operation.

7. The method of claim 1, further comprising:
based on determining that the refrigerator has battery-powered operation requirements, verifying whether the battery temperature is lower than the preset protection temperature;
based on determining that the battery temperature is lower than the preset protection temperature, causing the refrigerator to start operation; and
based on determining that the battery temperature is higher than or equal to the preset protection temperature, causing the refrigerator to stop operation.

8. The method of claim 1, further comprising:
after controlling the refrigerator to stop operation, causing the refrigerator to start operation based on one or more of:
determining that the battery temperature acquired is lower than a sixth preset temperature, or
determining that the battery temperature is lower than the preset protection temperature, wherein the sixth preset temperature is lower than the preset protection temperature.

9. A refrigerator comprising:
a compressor,
an evaporator,
a capillary,
a condenser,
a fan,
a battery, and
a controller,
wherein the compressor is connected with the evaporator and the condenser,
wherein the condenser is connected with the capillary,
wherein the capillary is connected with the evaporator,
wherein the fan is provided on the condenser,
wherein the compressor, the evaporator, the condenser, the fan and the controller are separately connected with the battery,
wherein the compressor, the evaporator, the condenser and the fan are separately connected with the controller,
wherein the controller is configured to:
acquire a battery temperature of the refrigerator;
based on determining that the battery temperature is greater than a first preset temperature and lower than a second preset temperature, cause a compressor of the refrigerator to operate at a lower tap position, wherein the first preset temperature and the second preset temperature are both lower than a preset protection temperature; and
based on determining that the battery temperature is lower than or equal to the first preset temperature, cause the compressor to operate at a current tap position.

10. The refrigerator of claim 9, wherein the refrigerator further comprises:
a compressor bin, wherein the battery, the compressor, the condenser and the fan are provided inside the compressor bin.

11. The refrigerator of claim 9, wherein the controller is further configured to:
based on the determining that the battery temperature is greater than the first preset temperature and lower than the second preset temperature, cause a fan of the refrigerator to operate at a higher tap position, wherein the battery and the fan of the refrigerator are provided inside a same bin.

12. The refrigerator of claim 9, wherein the controller is further configured to:
based on the determining that the battery temperature is greater than the first preset temperature and lower than the second preset temperature, determine a number of tap positions to reduce; and
cause the compressor to reduce the number of tap positions.

13. The refrigerator of claim 9, wherein the controller is further configured to:
based on determining that the battery temperature is higher than the first preset temperature and lower than a third preset temperature, determine a first number of tap positions; and
based on determining that the battery temperature is higher than or equal to the third preset temperature and lower than the second preset temperature, determine a second number of tap positions, wherein the second number of tap positions is greater than the first number of tap positions.

14. The refrigerator of claim 9, wherein the controller is further configured to:
based on determining that the refrigerator operates in the battery-powered refrigeration mode and meets shutdown conditions, determine whether the battery temperature is lower than a fourth preset temperature;
based on determining that the battery temperature is lower than the fourth preset temperature, cause the fan and the compressor to shut down; and
based on determining that the battery temperature is higher than or equal to the fourth preset temperature and lower than the preset protection temperature, cause the compressor to stop operation and causing the fan to continue operation.

15. A method for controlling a battery-powered refrigerator, method comprising:
determining a battery temperature of the battery-powered refrigerator;
based on determining, by comparing the battery temperature to a threshold, that the battery temperature exceeds the threshold, causing modification of operating parameters of the battery-powered refrigerator by:
modifying one or more tap positions of a compressor of the battery-powered refrigerator; and
modifying a speed of a fan of the battery-powered refrigerator.

16. The method of claim 15, wherein the modifying the one or more tap positions of the compressor of the battery-powered refrigerator comprises reducing a number of tap positions of the compressor.

17. The method of claim 15, wherein the modifying the speed of a fan of the battery-powered refrigerator comprises increasing a speed of the fan.

18. The method of claim 15, wherein the modifying the one or more tap positions of the compressor of the battery-powered refrigerator comprises:
based on determining that the battery temperature exceeds a second threshold, causing the compressor to shut down.

19. The method of claim 15, further comprising:
based on determining that a period of time has elapsed, modifying the one or more tap positions of the compressor back to a default setting.

20. The method of claim 15, further comprising:
based on determining that the battery temperature has lowered beneath the threshold, modifying the one or more tap positions of the compressor back to a default setting.
